(19) United States
(12) Patent Application Publication
(10) Pub. No.: US 2020/0158521 A1
(43) Pub. Date: May 21, 2020

(54) AUTOMATIC DRIVING DEVICE

(71) Applicant: TOYOTA JIDOSHA KABUSHIKI KAISHA, Toyota-shi (JP)

(72) Inventors: AKIRA IIJIMA, Nagoya-shi (JP); Hiroaki SAKAKIBARA, Nagoya-shi (JP)

(73) Assignee: TOYOTA JIDOSHA KABUSHIKI KAISHA, Toyota-shi (JP)

(21) Appl. No.: 16/591,098

(22) Filed: Oct. 2, 2019

(30) Foreign Application Priority Data
Nov. 19, 2018 (JP) 2018-216597

(51) Int. Cl. G01C 21/34; G05D 1/02; G01C 21/36

(52) U.S. Cl. CPC G01C 21/3415; G01C 21/3492; G05D 2201/0212; G01C 21/3661; G05D 1/0276

(57) ABSTRACT

An automatic driving device controls a vehicle based on a destination and a travel route specified from an outside. The automatic driving device includes: reception means for receiving first information indicating whether or not a route where the vehicle actually travels matches the specified travel route; and notification means for notifying, when the route where the vehicle actually travels matches the specified travel route, information indicating that the route where the vehicle travels under control of the automatic driving device matches the specified travel route, and notifying, when the route where the vehicle actually travels does not match the specified travel route, information indicating that the route where the vehicle travels under control of the automatic driving device does not match the specified travel route.

### INCORPORATION BY REFERENCE

The disclosure of Japanese Patent Application No. 2018-216597 filed on Nov. 19, 2018 including the specification, drawings and abstract is incorporated herein by reference in its entirety.

### BACKGROUND

### 1. Technical Field

The present disclosure relates to an automatic driving device.

### 2. Description of Related Art

In recent years, automatic driving devices have been developed which control a steering (steering), an accelerator (acceleration), and a brake (braking) while recognizing the situation surrounding the vehicle, so as to allow traveling of a vehicle without a driver performing driving operation.

Japanese Patent Application Publication No. 2018-142219 (JP 2018-142219 A) discloses an automatic driving device including a notification unit that notifies present situation information indicating that a vehicle travels toward a destination, in order to reduce “the anxiety of a user regarding a destination of the vehicle, when the user largely depends on automatic driving in traveling of the vehicle.”

Japanese Patent Application Publication No. 2009-97874 (JP 2009-97874 A) relates to an in-vehicle device including a dedicated short range communications (DSRC) unit that establishes a wireless communication with a center device to receive content information and output the received content information by voice, and a car navigation unit that outputs guidance information by voice. The in-vehicle device includes control means for performing voice output of any one of the content information and the guidance information, when both the pieces of information are approximately the same in content.

### SUMMARY

However, route guidance information from the navigation device may be different from the route where the vehicle actually travels under control of the automatic driving device. Accordingly, simply indicating that the vehicle travels toward the destination as in JP 2018-142219 A may be not enough to eliminate the anxiety of the driver or the like.

Moreover, since there is a possibility that the navigation device may be provided by a third party, there are cases where it is not necessarily practical to change a display mode depending on the sameness of the information content as in JP 2009-97874 A.

Accordingly, it is an object of the present disclosure to provide an automatic driving device capable of reducing the anxiety of a driver or the like, even when route guidance information based on a navigation device provided by a third party does not match a travel route where a vehicle actually travels under control of the automatic driving device.

An automatic driving device according to one aspect of the present disclosure can control a vehicle based on a destination and a travel route specified from an outside. The automatic driving device includes a receiver and a notifier. The receiver receives first information indicating whether or not a route where the vehicle actually travels matches the specified travel route. The notifier notifies, when the route where the vehicle actually travels matches the specified travel route, information indicating that the route where the vehicle travels under control of the automatic driving device matches the specified travel route. The notifier notifies, when the route where the vehicle actually travels does not match the specified travel route, information indicating that the route where the vehicle travels under control of the automatic driving device does not match the specified travel route.

The receiver may be configured to receive the first information from a navigation device that receives the specified destination and the travel route.

The receiver may be configured to receive destination information indicating the destination from a navigation device. The automatic driving device may include an acquirer that acquires travel route history information indicating a past travel route of the vehicle, based on the destination information. The notifier may be configured to notify, based on the travel route history information, information indicating that the route where the vehicle is scheduled to travel under control of the automatic driving device does not match the specified travel route.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a functional block diagram of an in-vehicle system 10 and a navigation device 20;

FIG. 2 is a schematic view showing an example where a main display 42, a head-up display (HUD) 44, and speakers 46, 48 of the in-vehicle system 10 are disposed in a vehicle;

FIG. 3 is a flowchart of a notification function implemented by an automatic driving device 30;

FIG. 4 is a flowchart for registering a vehicle behavior change spot;

FIG. 5 is a flowchart for notifying that the navigation device 20 and the automatic driving device 30 are not in cooperation; and

FIG. 6 is a flowchart for notifying that the navigation device 20 and the automatic driving device 30 are not in cooperation.

### DETAILED DESCRIPTION OF EMBODIMENTS

Embodiments of the present disclosure will be described hereinbelow with reference to the drawings. It should be understood that the following embodiments are only illustrative for explanation of the present disclosure and are not intended to limit the present disclosure to the embodiments.

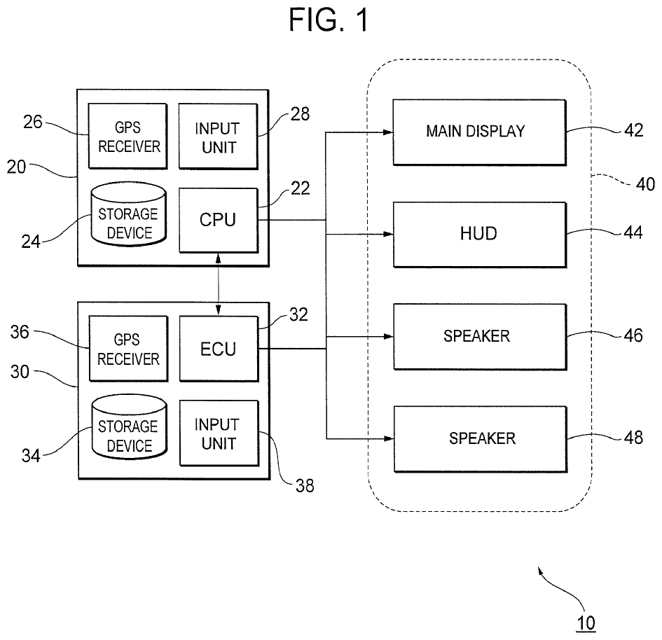

FIG. 1 shows a block diagram of an in-vehicle system 10 and a navigation device 20 according to the present embodiment. The in-vehicle system 10 includes an automatic driving device 30 and an information output device 40 mounted on a vehicle in advance. The navigation device 20 is used while being connected to such an in-vehicle system 10. For example, the navigation device 20 is configured of a computer program for navigation that is provided as application software from a third party, and an information processing terminal such as a smartphone that executes the computer program.

The navigation device 20 includes a storage device 24, a GPS receiver 26, an input unit 28, and a processor 22 (CPU). The navigation device 20 searches for, on application software, a route for reaching a destination that is input from the input unit 28 based on current location information received from the GPS receiver 26 and on map data. The navigation device 20 also generates an output instruction signal for causing the information output device 40 to output route guidance information used for traveling along a route specified by a driver or the like, and outputs the generated output instruction signal to the information output device 40.

The storage device 24 includes, for example, a nonvolatile storage device configured of a semiconductor memory, or the like, on which data such as a computer program for navigation and an operation system is recorded. The storage device 24 also includes a cache memory configured of a DRAM, SRAM, or the like, for temporarily storing map data from the outside and arithmetic processing data processed by the processor 22. The map data includes facility information, address information, and location information regarding specific points called nodes, such as intersections of roads. The map data also includes information corresponding to so-called links that are roads connecting the nodes. The location information is indicated by latitude, longitude, and altitude, for example. The map data and the like may be recorded on the storage device 24 in advance.

The GPS receiver 26 acquires location information regarding a vehicle from an unshown antenna that receives signals from GPS Satellites. The location information is indicated by latitude, longitude, and altitude, for example.

The input unit 28 is means used by the driver of a vehicle, or the like, to input data such as a destination. For example, the input unit 28 may be configured of a touch panel included in an information processing terminal that functions as the navigation device 20. The input unit 28 may include a microphone for inputting data such as a destination uttered by the driver or the like. The input unit 28 may further be configured of a touch panel mounted on the main display 42 or a microphone mounted on the vehicle.

The CPU 22 searches for a place of departure based on the location information received from GPS receiver 26 or a place of departure input from the input unit 28, and one or more routes to the destination input from the input unit 28, with reference to the map data stored in the storage device 24. The CPU 22 displays the search result on the main display 42, a display of the information processing terminal, or the like. When the driver or the like specifies a route, the CPU 22 records the specified route information on a cache memory device or the like. The route information includes information on a plurality of links that connect a plurality of nodes present between the place of departure and the destination.

The CPU 22 further transmits an output instruction signal to the information output device 40 for outputting route guidance information used for guiding the route to the destination, based on the information on the current location of the vehicle acquired with use of the GPS receiver 26 during traveling of the vehicle and on the set route information. The output instruction signal includes output setting information for causing the prescribed output device to output route guidance information of a prescribed type. For example, the CPU 22 transmits to the information output device 40 an output instruction signal for outputting image information on the main display 42 and outputting voice from the speaker 46 at the same time.

The automatic driving device 30 includes a storage device 34, a GPS receiver 36, an input unit 38, and an ECU 32. Processors included in the storage device 34, the GPS receiver 36, the input unit 38, and the ECU 32 have the same functions as the storage device 24, the GPS receiver 26, the input unit 28, and the CPU 22 of the navigation device 20, respectively. A redundant description, therefore, will be omitted. Hence, the automatic driving device 30 also has a function of a navigation device that sets a travel route by automatic driving and outputs route guidance information. Hereinafter, the navigation function implemented by the automatic driving device 30 is referred to as a native navigation function.

Based on information acquired from in-vehicle sensors, including a laser imaging detection and ranging (LiDAR), a millimeter-wave radar, and an imaging device such as a camera, the ECU 32 recognizes peripheral environments (such as surrounding vehicles, pedestrians, white lines defining road lanes or the like, and traffic signals) that vary dynamically, and acquires vehicle location information and vehicle posture that are more accurate than the vehicle location information acquired by the GPS receiver 26 of the navigation device 20. The ECU 32 can also set a travel route plan (lane plan) including a lane change, based on the acquired peripheral environments and vehicle location information. The location information includes sets of information that identify the link where the vehicle is currently present, the lane where the vehicle is currently present, a relative position on the lane where the vehicle is currently present, and a three dimensional location where the vehicle is currently present, respectively.

Here, the route information set by the navigation device 20 is in a unit of a link that connects nodes such as intersections, whereas the route information set by the automatic driving device 30 includes information that identifies a plurality of lanes that may be present on a single link. The route information set by the automatic driving device 30 further includes route information in a unit called a path that is shorter than the link. Accordingly, the route information set by the automatic driving device 30 has a higher resolution than the route information set by the navigation device 20. While the route information set by the navigation device 20 is static in principle, the route information set by the automatic driving device 30 may dynamically change depending on the peripheral environments, such as other vehicles.

The ECU 32 can transmit to the information output device 40 an output instruction signal for outputting the route guidance information based on a lane plan. The ECU 32 is further configured to be able to generate control data for controlling devices such as a steering, an accelerator, and a brake based on the set lane plan, and output the control data to each actuator.

The storage device 34 also stores computer programs for executing a route planning algorithm for the lane plan and arithmetic processes shown in the respective flowcharts in the present disclosure. Each of the arithmetic processes can be executed when hardware and firmware such as the processor of the ECU 32 (for example, an arithmetic device made of a semiconductor integrated circuit such as an application specific integrated circuit) process these computer programs.

The automatic driving device 30 and the navigation device 20 may include a partially shared configuration. For example, the automatic driving device 30 and the navigation device 20 may be configured to be able to access a shared storage device where data such as map data is recorded. The ECU 32 and the CPU 22 are configured to be communicable with each other.

The information output device 40 includes a main display 42 and a head up display (HUD) 44 that can display an image and a text, and two speakers 46, 48 that can output voice and sound effects. The information output device 40 may include a processor and firmware for controlling each of the output devices (the main display 42, the HUD 44, the speaker 46, and the speaker 48) based on an output instruction signal received from the navigation device 20 or the automatic driving device 30. The information output device 40 may further include a storage device that stores data (image data, voice data, and sound effect data) to be output. The information output device 40 may be configured to read and output specified data, based on an output instruction signal received from the navigation device 20 or the automatic driving device 30, or may be configured to receive the data from the navigation device 20 or the automatic driving device 30.

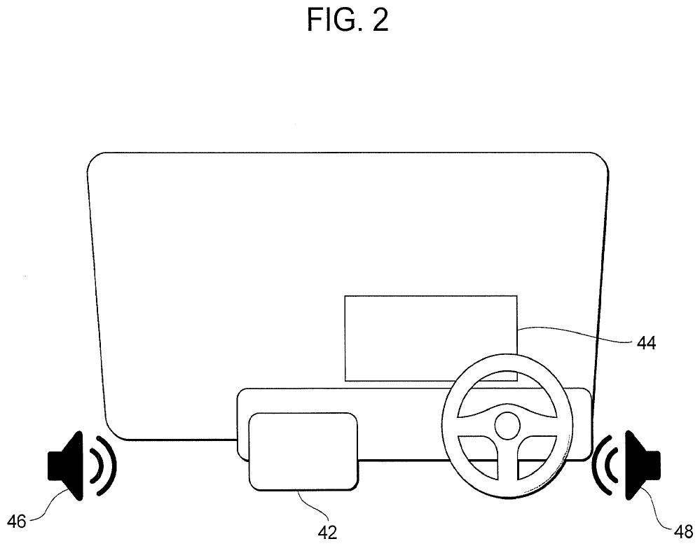

FIG. 2 shows an example where the information output device 40 is disposed inside a vehicle. The main display 42 is a display device made of a liquid crystal display installed on a dashboard. A driver and other passengers can view an image and a text displayed on the main display 42. The HUD 44 is a projection display device that makes a windshield glass reflect a video image projected from a source of projection and makes the driver visually recognize the video image as a virtual image. The speakers 46, 48 are installed on the right and left front sides of the vehicle, respectively.

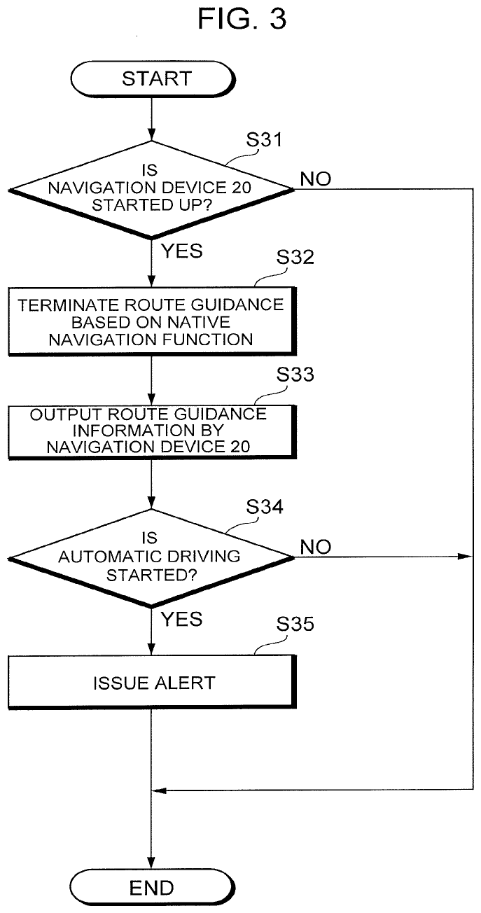

Hereinafter, description will be given of a method for notifying route related information according to the present embodiment with reference to the flowchart shown in FIG. 3, the method being performed when a vehicle mounted with the automatic driving device 30 is automatically driven at an automatic driving level 2.

Here, examples of the automatic driving levels in automatic driving modes defined by National Highway Traffic Safety Administration (NHTSA) or other organizations will be described.

### Automatic Driving Level 1 (Driver Assistance)

Automatic driving level 1 is a driving mode where an automatic driving device can implement any one of a steering (steering), an accelerator (acceleration), and a brake (braking). The driver needs to operate the vehicle.

### Automatic Driving Level 2 (Partial Automation)

Automatic driving level 2 is a driving mode where the automatic driving device can simultaneously implement some of the steering, the accelerator, and the brake. In the automatic driving level 2, the automatic driving device controls the steering and vehicle speed based on the information acquired from the periphery of the vehicle (including a road surface and other vehicles) with use of various sensors mounted on the vehicle. The driver needs to operate the vehicle in case of emergency or the like.

### Automatic Driving Level 3 (Conditional Automation)

The automatic driving level 3 is a driving mode where the automatic driving device can simultaneously implement all the operations of the steering, the accelerator, and the brake. The automatic driving device performs full automatic driving of the vehicle based on various information obtainable from sensors, communication means, or the like. The driver needs to operate the vehicle in case of emergency or the like.

Therefore, in the automatic driving level 3, it is desirable that the driver can operate the vehicle as necessary with assistance of route guidance based on the native navigation function of the navigation device 20 or the automatic driving device 30, while implementing automatic driving with the automatic driving device 30.

In step S31 in FIG. 3, a driver or the like can start up the navigation device 20 by executing application software installed in the information processing terminal. The driver or the like can operate the navigation device 20 and the in-vehicle system 10 in cooperation by connecting the navigation device 20 to the in-vehicle system 10 by wireless or wired communication means. At the time, the ECU 32 detects that the navigation device 20 is started up and is connected to the in-vehicle system 10.

In step S32, when startup of the navigation device 20 is detected, the ECU 32 terminates the route guidance based on the native navigation function included in the automatic driving device 30.

When priority is given to the route guidance based on the navigation device 20 over the route guidance based on the native navigation function in this way, it becomes possible to use the latest map data or the like that can be acquired by the information processing terminal that functions as the navigation device 20 through the Internet, and to reproduce music data or the like, recorded on the information processing terminal, from the speaker 46 or the like by operating the main display 42. The driver or the like can input data such as a destination, and specify a travel route with use of the information processing terminal. Since history information regarding places where the driver or the like has visited in the past may be recorded on the information processing terminal, it may be possible to easily input data such as a destination. There is also an advantage that passengers other than the driver can easily input data such as a destination even during traveling. The data such as a destination may also be input with use of a touch panel function of the main display 42 that has a larger screen.

The application software of the navigation device 20 may be configured to be used in cooperation with application software such as application software for map and application software for voice recognition that are recorded on the information processing terminal. A computer program to establish cooperation with the application software of the navigation device 20 is recorded on the storage device 34 of the automatic driving device 30. Accordingly, when the navigation device 20 is connected to the in-vehicle system 10, it becomes possible to perform operations such as transmitting the information input from the in-vehicle system 10 to the navigation device 20 to conduct a search for a travel route, and displaying on the main display 42 of the in-vehicle system 10 the route information searched in the navigation device 20 or the route guidance information from the navigation device 20.

In step S33, the CPU 22 of the navigation device 20 outputs an output instruction signal for causing the information output device 40 to output route guidance information, based on the route information that is searched by the navigation device 20 and specified by the driver or the like. Here, the route information includes information on a plurality of links that connect a plurality of nodes that are present between the place of departure and the destination. For example, when the vehicle approaches a point where route guidance is necessary, such as when the vehicle advances to a right branch, the CPU 22 transmits to the information output device 40 an output instruction signal for outputting route guidance information for encouraging to take the right branch. The main display 42 and the speaker 46 or the like output route guidance information based on the output instruction signal. Therefore, when automatic driving is not performed, the driver can drive the vehicle in accordance with the route guidance information based on the route information that is searched by the navigation device 20.

In step S34, when automatic driving using the automatic driving device 30 is started, the ECU 32 of the automatic driving device 30 searches for a travel route, calculates route information including a lane plan, and performs automatic driving based on the calculated route information. For example, in the case where roadworks are conducted in a lane where the vehicle is traveling and a lane on the right side in a three-lane road, the ECU 32 generates control data for controlling the steering, the accelerator, and the brake, and the like for changing the lane to a left-side lane, and outputs the control data to each of the actuators. As described above, the route information calculated and set by the ECU 32 includes the information that specifies the lanes that may be present on a single link, and also includes the route information in a unit called a path that is shorter than the link. Accordingly, the route information set by the automatic driving device 30 has a higher resolution than the route information set by the navigation device 20, and therefore even when both the route information includes the same section, the route information set by the automatic driving device 30 may include more points to be linked in the same section. Step S34 may be configured to be executed in parallel to or in prior to steps S31 to S33.

Here, the inventors of this application paid attention to the point that the route information searched based on the navigation device 20 and the route information searched based on the automatic driving device 30 do not match in some cases. For example, as stated above, the mode selected for a travel route set by the automatic driving device 30 may be an automatic driving mode where the vehicle is set to travel on the same lane. The travel route set by the automatic driving device 30 may also dynamically be changed corresponding to the surrounding traffic situations or the like. The navigation device 20 and the automatic driving device 30 may use difference algorithms for route search. The travel routes by the navigation device 20 and the automatic driving device 30 may also differ due to difference in resolution, and difference in map data, or the like, used as a basis for their route search.

However, when the route where the vehicle actually travels does not match the travel route specified based on the navigation device 20, the driver or the like may undesirably cancel automatic driving in an attempt to travel in accordance with the travel route.

In step S35, when receiving from the navigation device 20 information indicating whether or not the travel route where the vehicle actually travels is the specified travel route, the automatic driving device 30 according to the present embodiment is configured to notify the information and cause the information output device 40 to display the information. Specifically, when receiving from the navigation device 20 information indicating that the location information from the GPS receiver 26 does not match the set travel route as a result of comparison therebetween, the ECU 32 is configured to generate an output instruction signal to warn that the automatic driving device 30 and the navigation device 20 are not in cooperation and therefore the actual travel route by the automatic driving device 30 does not match the travel route specified based on the navigation device 20, and display the warning on the main display 42 or the HUD 44. For example, an icon indicating that the navigation device 20 and the automatic driving device 30 are not in cooperation can be displayed in the vicinity of a meter display. Accordingly, even when the actual travel route is different from the specified travel route, it is possible to reduce the anxiety of the driver or the like, and to avoid cancellation of that automatic driving.

When the ECU 32 does not receive from the navigation device 20 the information indicating that the location information from the GPS receiver 26 does not match the set travel route as a result of comparison therebetween, the ECU 32 may be configured to notify, in every prescribed period or on a constant basis, the information indicating that the route where the vehicle travels under control of the automatic driving device 30 matches the specified travel route.

### First Modification

A modification of the above-described embodiment will be described below. In the present modification, a past travel route history is recorded on the storage device 34. The ECU 32 compares the past travel routes with a travel route based on the automatic driving device 30 so as to estimate in advance a spot which may possibly deviate from the travel route, and notifies the estimated spot. Hereinafter, description of the similar configuration is omitted, and different points are mainly described.

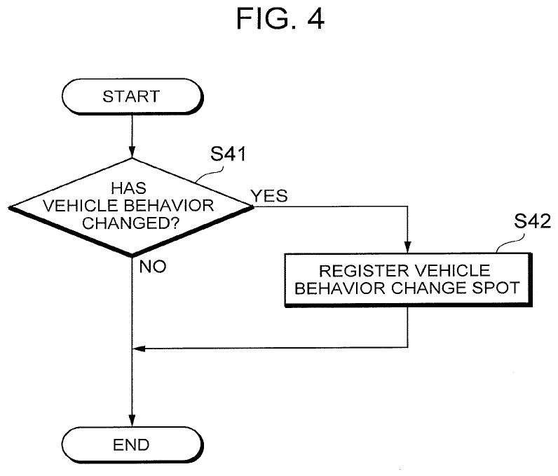

FIG. 4 is a flowchart for registering a vehicle behavior change spot. The automatic driving device 30 stores past travel routes in the storage device 34. The travel routes may be the travel routes where automatic driving by the automatic driving device 30 is not performed. In step S41, the ECU 32 compares a scheduled travel route by the automatic driving device 30 with the past travel routes stored in the storage device 34 based on destination information input from the input unit 28 or 38. The ECU 32 determines the presence of a point where the behavior of the vehicle, that is, the behavior of the vehicle controlled by the automatic driving device 30, is different from the behavior of the vehicle in the case of following the route guidance by the navigation device 20. When such a point is present, the ECU 32 registers the point on the storage device 34 as a vehicle behavior change spot in step S42. In the above embodiment, when receiving from the navigation device 20 the information indicating that the location information from the

GPS receiver 26 does not match the set travel route as a result of comparison therebetween, the ECU 32 may register the point at that time as a behavior change spot.

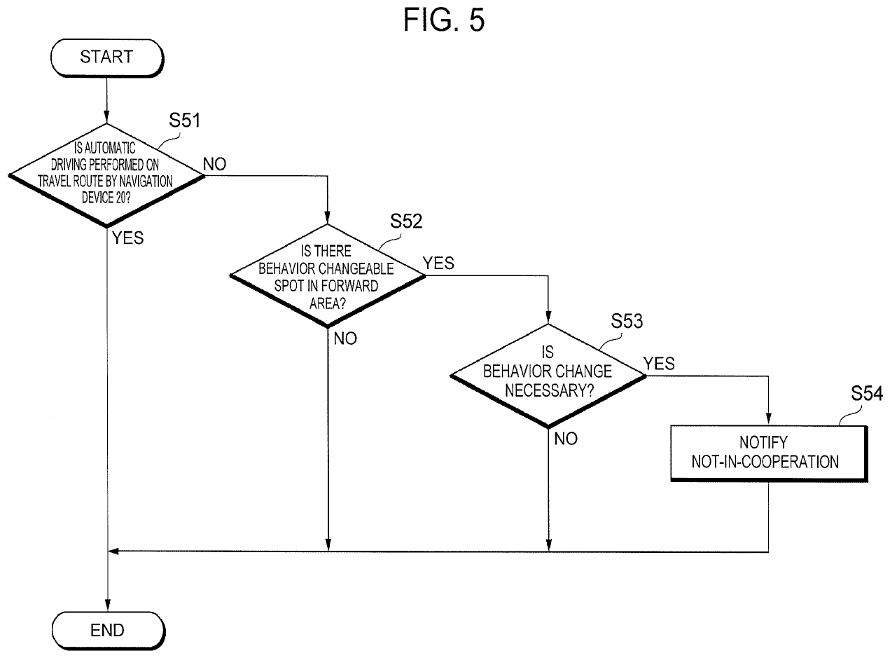

FIG. 5 shows a flowchart for notifying that the travel route of the navigation device 20 and the actual travel route by the automatic driving device 30 are not in cooperation based on the registered behavior change spot.

First in step S51, the ECU 32 determines whether or not automatic driving by the automatic driving device 30 is in cooperation with the travel route of the navigation device 20. For example, when both the devices are in cooperation, and automatic driving by the automatic driving device 30 is performed in accordance with the travel route of the navigation device 20, the ECU 32 determines “YES.”

When determining “NO” in step S51, the ECU 32 determines whether or not there is a behavior changeable spot in a forward area in step S52. For example, the forward area refers to an area within 700 m ahead. The ECU 32 determines the presence of the behavior changeable spot which refers to a spot where there is a possibility that the behavior of the vehicle may change. For example, when the vehicle travels straight for a while, the ECU 32 determines “NO” in step S52.

When determining “YES” in step S52, the ECU 32 determines in step S53 whether or not the behavior changeable spot is included in the behavior change spots registered in step S42. When the behavior changeable spot is the spot registered as a behavior change spot, the ECU 32 displays on the HUD 44 an icon or the like indicating that the navigation device 20 and the automatic driving device 30 are not in cooperation in step S53. Therefore, the driver or the like can recognize that there is a possibility that the actual travel route is different from the specified travel route.

Thus, based on the past travel route information, the vehicle behavior change spot can be predicted, and not-in-cooperation can be highlighted with use of a display of the HUD 44 or the like, or can be output by voice with use of the speakers 46, 48 in advance. This makes it possible to reduce the anxiety of the driver or the like.

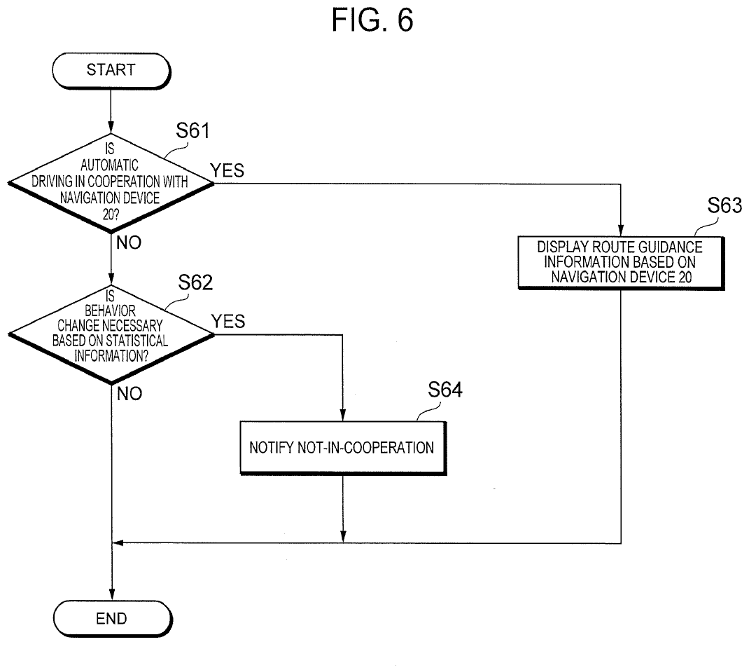

As in a flowchart shown in FIG. 6, the presence of a behavior change spot may be determined based on past statistical information. Specifically, in step S61, the ECU 32 determines whether or not the automatic driving device 30 and the navigation device 20 are in cooperation, and that the travel route for automatic driving by the automatic driving device 30 is set by the navigation device 20. When determining “YES”, the ECU 32 causes the information output device 40 to output route guidance information based on the travel route set by the navigation device 20 in step S63. When determining “NO” in step S61, the ECU 32 determines whether or not the behavior change of the vehicle is necessary changed based on the past statistical information in step S62. The past statistical information may be information on one's own vehicle or other vehicles that have traveled on the same travel route in the past. The past statistical information may also be configured to be acquired through the Internet or the like. When the vehicle traveling by automatic driving passes through the point which may require change of the vehicle behavior, not-in-cooperation can be highlighted with use of the display of the HUD 44 or the like, or can be output by voice with use of the speakers 46, 48 in advance in step S64

Thus, based on the past travel route information, the vehicle behavior change spot can be predicted, and not-in-cooperation can be highlighted with use of the display of the HUD 44 or the like, or can be output by voice with use of the speakers 46, 48 in advance. This makes it possible to reduce the anxiety of the driver or the like. The present disclosure is applicable at other automatic driving levels. Moreover, various deformations of the present disclosure are possible without departing from the scope of the disclosure.

What is claimed is:

1. An automatic driving device that controls a vehicle based on a destination and a travel route specified from an outside, the automatic driving device comprising:
a receiver that receives first information indicating whether or not a route where the vehicle actually travels matches the specified travel route; and
a notifier that
notifies, when the route where the vehicle actually travels matches the specified travel route, information indicating that the route where the vehicle travels under control of the automatic driving device matches the specified travel route and
notifies, when the route where the vehicle actually travels does not match the specified travel route, information indicating that the route where the vehicle travels under control of the automatic driving device does not match the specified travel route.

2. The automatic driving device according to claim 1, wherein the receiver is configured to receive the first information from a navigation device that receives the specified destination and the travel route.

3. The automatic driving device according to claim 2, further comprising an acquirer that acquires travel route history information indicating a past travel route of the vehicle, wherein
the notifier is configured to notify, based on the travel route history information, information indicating that the route where the vehicle is scheduled to travel under control of the automatic driving device does not match the specified travel route.

4. An automatic driving device mounted on a vehicle including an output device that outputs information for guiding a travel route of the vehicle, the automatic driving device comprising:
a travel route setting device that sets the travel route of the vehicle; and
a controller that controls the vehicle to travel based on the set travel route, wherein:
when a navigation device, configured to set a first route for moving from a first point to a second point, is connected to the vehicle, the travel route setting device sets a second route for moving from the first point to the second point, the second route being different from the first route;
the controller is configured to control the vehicle based on the second route; and
the output device is configured to output information for guiding a travel route based on the first route, and information indicating that the vehicle travels on a route different from the first route.
